(19) United States
(12) Patent Application Publication
(10) Pub. No.: US 2025/0020449 A1
(43) Pub. Date: Jan. 16, 2025

(54) METHOD AND APPARATUS FOR MEASURING THE THICKNESS OF ONE OR MORE LAYERS OF A MULTI-LAYER FILM

(71) Applicant: SYNCRO S.R.L., Busto Arsizio VA (IT)

(72) Inventor: Marco BRANCA, Busto Arsizio VA (IT)

(73) Assignee: SYNCRO S.R.L., Busto Arsizio VA (IT)

(21) Appl. No.: 18/711,291

(22) PCT Filed: Nov. 16, 2022
(86) PCT No.: PCT/IB2022/061029

§ 371 Date: May 17, 2024

(30) Foreign Application Priority Data
Nov. 19, 2021 (IT) 102021000029324

(51) Int. Cl. G01B 11/06; G01B 7/06; G01B 7/14

(52) U.S. Cl. CPC G01B 11/0616; G01B 7/085; G01B 7/14

(57) ABSTRACT

A method is described for measuring, in a multi-layer film having one or more layers of a first and a second material, the total thickness of the first material and/or the second material. The method includes: a) acquiring, by means of an optical or an ionizing radiation sensor, a first measurement signal (Sₒₜₜ) representative of the total thickness of the film; b) acquiring, by means of a capacitive sensor, a second measurement signal which is the sum of the signals given by the first and second material of the film. The signal given by each material of the film is a function of the thickness of the material; and c) calculating, from the first and second signal, the total thickness of the first material and/or the second material.

### TECHNICAL FIELD OF THE INVENTION

The present invention relates to a method and apparatus for measuring the thickness of one or more layers of a multi-layer film, i.e. a film formed by a plurality of overlapping layers of different materials.

More particularly, the present invention relates to a method and apparatus for measuring, in a multi-layer film formed by one or more layers of a first material and one or more layers of a second material, the total thickness of the first material (i.e. the thickness of the layer of the first material, in case of a film containing only one layer of the first material, or the sum of the thicknesses of the layers of the first material, in case of a film containing several layers of the first material) and the total thickness of the second material (i.e. the thickness of the layer of the second material, in case of a film containing only one layer of the second material, or the sum of the thicknesses of the layers of the second material, in case of a film containing several layers of the second material).

### STATE OF THE ART

The use of multi-layer films comprising one or more so-called “barrier” inner layers, whose function is to prevent the passage of gases, in particular oxygen, is widespread, for example in the food industry. Such barrier layers are for example made of EVOH. In a multi-layer film, there may be one or more barrier layers, normally arranged within the film, with adjacent layers of other material. The multi-layer film may for example comprise the following sequence of three layers: neutral material, EVOH, neutral material, where the neutral material is for example polyethylene. In the case of two barrier layers, the multi-layer film may for example comprise the following sequence of five layers: neutral material, EVOH, neutral material, EVOH, neutral material.

Knowing in-line the exact thickness of the individual layers of a multi-layer film, in particular of the barrier layer, if any, would offer several advantages to the manufacturers of multi-layer films, such as the possibility to monitor the product precisely, the possibility to detect any defects in the composition of the individual layers of the film at an early stage, and the possibility to modify and develop the film recipe, if necessary, with a direct in-line control. There is therefore a need to provide manufacturers of multi-layer films with a solution that allows them to reliably, quickly and effectively measure the thickness of the individual layers of a multi-layer film.

Solutions for measuring the thickness of individual layers of a multi-layer film are already known, but they suffer from a number of drawbacks, in particular the fact that they do not allow a quick and conveniently applicable in-line measurement of the thickness of the layer(s) of material of interest.

For example, EP2026032 discloses a method for measuring the thickness of a layer of a first material in a film also comprising a second material, based on the comparison of the signal obtained by a measuring device, in particular a capacitive one, when the layer in question is present, with the signal obtained when the layer in question is not present, i.e. when the film consists only of the second material.

EP1205293 discloses a method for measuring the thickness of a layer of material in a multi-layer film based on performing several capacitance measurements under different conditions, in particular at different temperatures.

DE102011051601 discloses a system for measuring the thickness of a flat material, such as a plastic film, using an inductive sensor and an optical sensor mounted coaxially to the inductive sensor, wherein the inductive sensor measures the distance from the bottom side of the flat material, wherein the optical sensor measures the distance from the top side of the flat material, and wherein the thickness of the flat material is derived as the difference between the two distances thus measured. Such a system does not allow to measure the thickness of the various layers of material of a multi-layer material.

Furthermore, EP1969304 discloses a method for determining the thickness of multi-layer films comprising layers of various non-conductive materials, using a first sensor, a second sensor and possibly further sensors. The first sensor measures the overall thickness profile of the film with a short measurement cycle lasting approximately 1-2 minutes, but with a considerable margin of error, while the second sensor measures the overall thickness profile of the film with a small margin of error, but with a measurement cycle lasting longer, approximately 10 to 30 minutes. By comparing the two thickness profiles thus obtained, a correction profile is calculated for the first sensor, which can be applied to all the thickness profiles measured by that sensor, until a more accurate thickness profile becomes available from the second sensor with which to calculate a new correction profile.

### SUMMARY OF THE INVENTION

It is an object of the present invention to provide a method and apparatus for measuring in-line, i.e. during the manufacturing process of a multi-layer film, the thickness of a layer, in particular of a layer of barrier material, of the film.

This and other objects are fully achieved, according to a first aspect of the present invention, by a method as defined in the appended independent claim 1 and, according to a further aspect of the present invention, by an apparatus as defined in the appended independent claim 9.

Advantageous ways for carrying out the method according to the invention, as well as advantageous embodiments of the apparatus according to the invention, are defined in the dependent claims, the subject-matter of which is to be understood as forming an integral part of the present description.

In summary, the invention is based on the idea of using a first sensor made as an optical or ionizing radiation sensor and a second sensor made as a capacitive sensor, wherein the first sensor is configured to measure the total thickness of the film in a direct and absolute way, as well as independently of the composition and materials of the film, while the second sensor is configured to provide a measurement signal which is the sum of the signals given by the first and second materials of the film, wherein the signal given by each material of the film is a function of the thickness of said material (in case of more layers of the same material, the total thickness of said layers).

The first sensor is advantageously configured, in case of an optical sensor, to measure in a non-interferometric way the total thickness of the film, in particular through the shadow projected by the film as it is caused to move over a cylinder and hit by a focused optical beam. For this purpose, the first sensor comprises an emitting head, which is placed on one side of the cylinder and is configured to emit the optical beam against the film, and a receiving head, which is placed on the opposite side of the cylinder relative to the emitting head and is configured to analyse the shadow generated by the film as it is being hit by the optical beam so as to determine the total thickness of the film.

The second sensor (capacitive sensor), advantageously chosen as a contactless reflective sensor, is advantageously associated with a third sensor, in particular an inductive sensor, configured to measure the distance of the second sensor from the cylinder, so as to simultaneously provide a zero offset for the first sensor and, via the inductive signal provided by the third sensor, remove the contribution of the air to the capacitive signal provided by the second sensor.

The measurement system according to the invention, therefore, does not provide for the dependence on values, such as the dielectric constants of the materials of the film, as proposed in the aforementioned document EP1969304, which are to be provided in advance to the system leaving the possibility of introducing errors into the evaluation of the measurement. A source of error can be in particular the temperature, as the dielectric constants vary even more than 100 percent depending on the temperature of the material. The same can apply to intrinsic disturbances or differences between one machine and another or between one sensor and another, which makes it difficult to provide correct values of the measured quantities, unless samples and lengthy on-site sampling methods are used.

The measuring system according to the invention makes it possible to directly obtain the values L₁ and L₂ of the thickness of the layer(s) of the first material (for example a neutral material, such as polyethylene) and respectively of the thickness of the layer(s) of the second material (for example a barrier material, such as EVOH) from the optical signal S_{off} provided by the first sensor and the capacitive signal S_{cap} provided by the second sensor, based on the following system of equations:

$${S}_{ott} = {L}_{1} + {L}_{2} ; \qquad ( 1 )$$

$${S}_{cap} = {k}_{1} \cdot {L}_{1} + {k}_{2} \cdot {L}_{2} . \qquad ( 2 )$$

The parameters k₁ and k₂ can be determined in the following way. The parameter k₁ can be determined, during the first start-up phase of the film production plant, based on the signal S_{cap} provided by the second sensor when the film is formed by the first material only (and therefore L₂=0). The parameter k₂ is obtained from equation (2) using the average value of the signal S_{cap} and the average values of L₁ and L₂, based on the following equation:

$${k}_{2} = ( \overline{{S}_{cap}} - {k}_{1} \cdot \overline{{L}_{1}} ) / \overline{{L}_{2}} . \qquad ( 3 )$$

The average values of L₁ and L₂ can be provided by the dosing devices of the plant, for example of gravimetric type, which measure the quantities of the first material and of the second material fed into the plant. Alternatively, these average values can be set equal to the nominal values of L₁ and L₂.

The measuring system is thus able to calibrate itself continuously with no external intervention and can be used on any material without the need to know in advance the value of its dielectric constant, which eliminates a considerable source of error. The fact that the measurement obtained with such a measuring system is not dependent on the environmental conditions of the material, for example the temperature, also allows to eliminate an additional source of error.

A further advantage of the measuring system according to the invention is that the system does not require any further operations, for calibration purposes, than those which are already normally performed on the plant. For example, operating the plant to produce the neutral film only, without layer(s) of barrier material, is an operation that is already commonly performed when the plant is switched on, so that the calculation of the parameter k₁ in the manner illustrated above does not require performing a special operating step.

Furthermore, the measuring system operates correctly regardless of whether the layers to be measured are coloured, opaque or transparent. The only requirement is that the first material and the second material have dielectric constants that differ from each other, albeit by a small amount. This is usually not a problem for the materials (for example PE and EVOH) which are commonly used for multi-layer films provided with barrier layer(s), even under standard ambient temperature conditions. Therefore, there is no need for a temperature higher than standard room temperature to increase the dielectric difference between the materials, as it has been found experimentally that even at standard room temperature the invention is able to detect thicknesses in the order of a single micron of EVOH in a few tens of microns of PE.

A further advantage of the present invention is that the sensors operate in exactly the same place and under the same environmental conditions.

The measuring system also makes it possible to measure the thickness of the layers of a film consisting of more than two materials, provided that these materials are “similar”, i.e. are characterized by substantially equal relationships between the thickness and the signal generated by the second sensor (capacitive sensor). The measuring system in this case measures the thickness of the layers of two or more “similar” materials as if they were layers of the same material. For example, in a multi-layer film having in sequence a layer of neutral material, a layer of a first barrier material, a layer of a second barrier material, a further layer of the first barrier material and a further layer of the neutral material, wherein the two barrier materials are different materials but characterised by similar thickness-capacitive signal relationships, the measuring system would be able to measure the sum L₁ of the thicknesses of the two layers of neutral material and the sum L₂ of the thicknesses of the two layers of the first barrier material and the layer of the second barrier material.

The invention can be used both for the measurement of the thickness of layers of material in films produced by cast extrusion process, wherein the film is a single one, and for the measurement of the thickness of layers of material in films produced by blow extrusion process, wherein the film is often in the form of a flattened tube, and is therefore a “double” one, in which case the measuring system according to the invention allows a thickness profile to be determined for all the individual sectors of the bubble. In case of use of the invention in a blown film production plant, the fact that the measuring apparatus can be mounted away from the haul-off means that the measurement is not affected by changes in temperature, and therefore in dielectric constants, which may occur near the bubble.

### BRIEF DESCRIPTION OF THE DRAWINGS

Further features and advantages of the present invention will become clearer from the following description, given purely by way of non-limiting example with reference to the accompanying drawings, in which:

FIGS. 1 and 2 are a perspective view and a front view, respectively, of an apparatus for measuring the thickness of one or more layers of a multi-layer film according to an embodiment of the present invention; and

FIG. 3 is a schematic view of an apparatus for measuring the thickness of one or more layers of a multi-layer film according to a further embodiment of the present invention.

### DETAILED DESCRIPTION

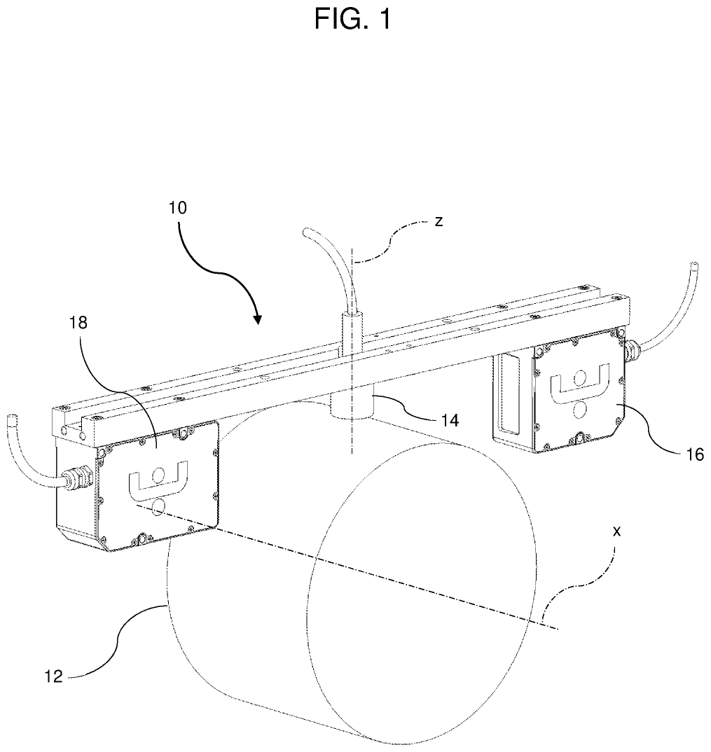

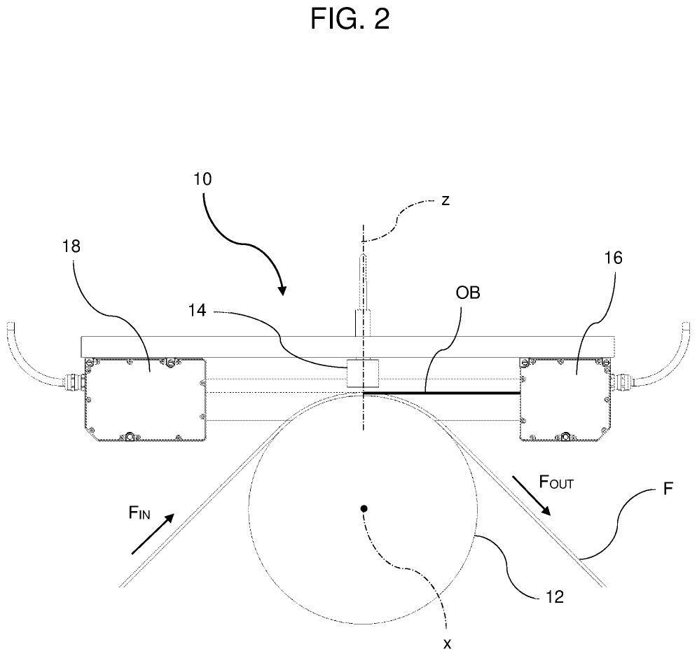

Referring first to FIGS. 1 and 2, a measuring apparatus configured to measure the thickness of one or more layers of a multi-layer film F, in particular a multi-layer film formed by one or more layers of a first material and one or more layers of a second material, is generally indicated 10. In the following description reference will be made to the case in which the film F comprises a pair of outer layers of PE as the first material and an inner layer of EVOH as the second material, but it is clear that the invention is also applicable to the measurement of the thickness of layers of a multi-layer films having a different number of layers and/or a different composition.

The measuring apparatus 10 can be installed at any point downstream of the extrusion head, in the case of a plant for the production of a multi-layer film by cast extrusion method, or downstream of the haul-off means, in the case of a plant for the production of a multi-layer film by blow extrusion process.

The measuring apparatus 10 comprises a cylinder 12 of metallic material, electrically grounded. The cylinder 12 is supported for rotation about its own axis (indicated by x), which is preferably oriented horizontally. The film F, which in case of use of the apparatus in a blow extrusion plant will be the flattened tubular film coming out of the haul-off means, is caused to move over the cylinder 12 (FIG. 2), so that the path of the film is deviated, that is, so that the film branch (indicated by arrow F_{OUT}) leaving the cylinder 12 does not extend along the same direction as the incoming film branch (indicated by arrow F_{IN}), but forms a certain angle with the latter, in particular an angle between 90° and 150°, preferably an angle between 90° and 120°.

The measuring apparatus 10 further comprises a capacitive sensor 14 arranged with its measurement axis (indicated z) in a plane, in particular a vertical plane, passing through the axis x of the cylinder 12, at a certain distance from the side surface of the cylinder 12. This distance depends on the specific sensor being used, but will typically be of the order of several millimetres.

The measuring apparatus 10 further comprises an optical sensor adapted to measure in a non-interferometric way the total thickness of the film F. In the example proposed herein, the optical sensor is a shadow projection optical sensor and is configured to detect the shadow projected by the film F as the latter is caused to move over the cylinder 12 and at the same time is hit by a focused optical beam. Thus, in this case, the optical sensor comprises an emitting head 16, which is placed on one side of the cylinder 12 (to the right of the cylinder, with respect to the point of view of a person looking at FIGS. 1 and 2) and is configured to emit an optical beam B, and a receiving head 18, which is placed on the opposite side of the cylinder 12 relative to the emitting head 16 (therefore, in the present case, on the left side of the cylinder, with respect to the point of view of a person looking at FIGS. 1 and 2) and is configured to analyse the shadow generated by the film F hit by the optical beam B in order to determine the total thickness of the film. The direction of the optical beam B lies in a plane perpendicular to the axis x of the cylinder 12 and is perpendicular to the axis z of the capacitive sensor 14.

Both the capacitive sensor 14 and the optical sensor 16, 18 therefore acquire their respective measurement signals on a section of film F in contact with the outer surface of the cylinder 12.

Advantageously, an inductive sensor (not shown, but in any case of a per-se-known type) is associated to the capacitive sensor 14, preferably integrated in the same capacitive sensor, which inductive sensor is arranged to measure the distance between the capacitive sensor 14 and the cylinder 12, so as to simultaneously provide a zero offset to the optical sensor and, via the inductive signal provided by the inductive sensor, remove the contribution of the air to the capacitive signal provided by the capacitive sensor 14.

As explained above, given a multi-layer film comprising one or more layers of a first material (for example, a neutral material such as PE) of total thickness L₁ and one or more layers of a second material (for example, a barrier material such as EVOH) of total thickness L₂, the values of the thicknesses L₁ and L₂ will be calculated by appropriate processing means (known per se) by solving the system of the above equations (1) and (2) based on the values of the signals Sₒₜₜ and S_{cap} supplied to those processing means by the optical sensor and the capacitive sensor, respectively. With regard to the parameters k₁ and k₂ appearing in equation (2), the former will advantageously be determined, during the first start-up phase of the film production plant, based on the signal S_{cap} provided by the capacitive sensor when the film is formed by the first material only (and thus L₂=0), while the latter will advantageously be determined during operation from equation (3) above, based on the average value of the signal S_{cap} and the average values of L₁ and L₂. The average values of L₁ and L₂ can, for example, be provided by gravimetric dosing devices, which measure the quantities of the first material and of the second material fed into the plant. Alternatively, the average values of L₁ and L₂ can be provided by the operator during calibration.

As an example, the measurement method is illustrated here in the case of a multi-layer film with a total thickness of 30 μm, of which 25 μm are made of PE and 5 μm are made of EVOH, and with a structure comprising a first layer of 12.5 μm of PE, a layer of 5 μm of EVOH and a second layer of 12.5 μm of PE. Once started-up, the plant will begin to produce a 25 μm film of PE, for which the optical sensor will provide a signal:

$${S}_{ott} = {L}_{1} = 25 μ m .$$

During this phase, the capacitive sensor will be measuring a non-calibrated (and therefore non-important) value, for example 40 μm. Equation (2) above will then become (since L₂=0):

$${S}_{cap} = {k}_{1} \cdot {L}_{1} = 40 μ m .$$

By entering the value L₁=25 μm measured with the optical sensor, the value of the first calibration coefficient is obtained:

$${k}_{1} = {S}_{cap} / {L}_{1} = 40 μ m / 25 μ m = 1.6 .$$

When EVOH is introduced into the plant, and thus the film contains both the layers of thickness L₁ and the layers of thickness L₂, the optical sensor will provide a measurement signal

$${S}_{ott} = {L}_{1} + {L}_{2} = 30 μ m .$$

while the capacitive sensor will still provide a non-calibrated measurement signal, for example 50 μm. Equation (2) above will then become:

$${S}_{cap} = 1.6 \cdot {L}_{1} + {k}_{2} \cdot {L}_{2} = 50 μ m .$$

At this point, a second calibration is performed to determine the coefficient k₂, using the average values of L₁ and L₂, i.e. L̅₁̅=25 μm and L̅₂̅=5 μm, which are provided, for example, by the dosing devices of the plant or are entered manually by the operator based on the nominal values or based on the values measured in laboratory.

From the above relationship, the following is obtained

$${k}_{2} = ( 50 μ m - 1.6 \cdot 25 μ m ) / 5 μ m = 2.$$

From this time onwards, the measuring apparatus will therefore be able to measure the thickness L₂ at any time.

If for some reason the plant were to produce a film with a varied structure, for example with a first layer of PE of 12 μm thickness, with an intermediate layer of EVOH of 6 μm thickness and with a second layer of PE of 14 μm thickness, the optical sensor and the capacitive sensor would provide the following signals:

$${S}_{ott} = 26 μ m + 6 μ m = 32 μ m$$

$${S}_{cap} = 1.6 \cdot 26 μ m + 2 \cdot 6 μ m = 53.6 μ m .$$

Based on these values of the signals Sₒₜₜ and S_{cap} provided by the optical sensor and the capacitive sensor, respectively, as well as on the values of the parameters k₁ and k₂ determined as described above, the measuring apparatus calculates the thicknesses L₁ and L₂ by solving the system of equations (1) and (2) and therefore obtaining the following results (which correspond exactly to the sum of the thicknesses of the two layers of PE and the thickness of the intermediate layer of EVOH):

$${L}_{2} = ( {S}_{cap} - {k}_{1} \cdot {S}_{ott} ) / ( {k}_{2} - {k}_{1} ) = ( 53.6 μ m - 1.6 \cdot 32 μ m ) / ( 2 - 1.6 ) = 6 μ m$$

$${L}_{1} = {S}_{ott} - {L}_{2} = 32 μ m - 6 μ m = 26 μ m .$$

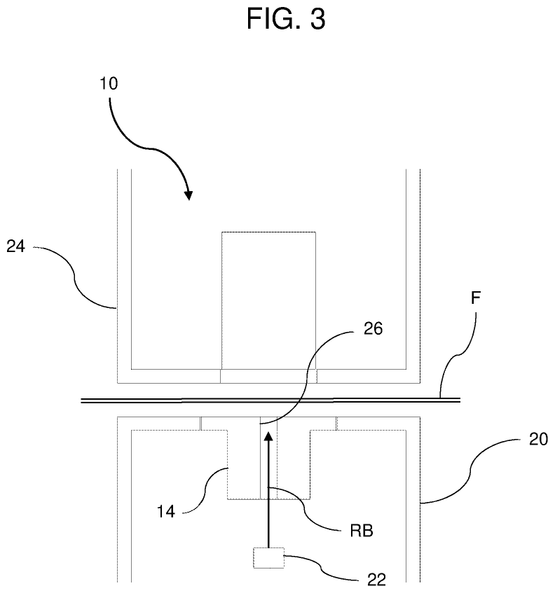

With reference now to FIG. 3, in which parts and elements identical or corresponding to those of FIGS. 1 and 2 have been assigned the same reference numerals, according to another embodiment of the invention there is provided, instead of the optical sensor, an ionizing radiation sensor arranged to perform the same function as the optical sensor, i.e. measuring the total thickness of the film independently of the composition of the latter, i.e. without any effect by the chemical composition of the film on the measurement provided by this sensor.

The ionizing radiation sensor is, for example, made as a transmission sensor, in which case it comprises an emitting head 20 provided with a source 22 for emitting a ionizing radiation beam RB towards the film F and a receiving head 24 for detecting the signal of the ionizing radiation beam RB passing through the film F, calculating its absorption and thus obtaining the total thickness of the film F. Preferably, as in the illustrated example, the capacitive sensor 14 (the function of which is identical to that described above with reference to the embodiment of FIGS. 1 and 2) is mounted on the emitting head 20 of the ionizing radiation sensor and has a through-hole 26 for allowing the passage of the ionizing radiation beam RB. The capacitive sensor 14 may be formed by two armatures, one on the face of the emitting head 20 facing the film F and the other on the face of the receiving head 24 facing the film F. Alternatively, the capacitive sensor 14 may be integrated into a single body comprising both armatures, so that the electric field lines start from and return to the capacitive sensor itself, passing through the film F.

The ionizing radiation sensor may, however, be made as a reflection sensor instead of a transmission sensor.

What has already been described above with reference to the embodiment of FIGS. 1 and 2 applies in all other respects.

The present invention has been described so far with reference to a preferred example thereof. It is to be understood that other embodiments and modes of carrying out the invention may be envisaged, which are based on the same inventive core as defined by the appended claims.

1. A method for measuring, in a multi-layer film (F) having one or more layers of a first material and one or more layers of a second material, the total thickness (L₁) of the first material and/or the total thickness (L₂) of the second material, comprising:
a) acquiring, by means of an optical sensor or an ionizing radiation sensor, a first measurement signal (Sₒₜₜ) representing in an absolute manner the total thickness of the film (F);
b) acquiring, by means of a capacitive sensor, a second measurement signal (S_{cap}) which is the sum of the signals given by the first and second material of the film (F), wherein the signal given by each material of the film (F) is a function of the thickness (L₁, L₂) of that material; and
c) calculating, from said first and second measurement signals (Sₒₜₜ, S_{cap}), the total thickness (L₁) of the first material and/or the total thickness (L₂) of the second material.

2. The method according to claim 1, wherein said steps a) and b) of acquiring a first measurement signal (Sₒₜₜ) and acquiring a second measurement signal (S_{cap}) are performed while the film (F) is being moved over a cylinder which deviates its path.

3. The method according to claim 2, wherein said step a) is performed by hitting the film (F) with a focused optical beam (OB) emitted by an emitting head of the optical sensor placed on one side of the cylinder and detecting the shadow projected by the film (F) by means of a receiving head of the optical sensor placed on the opposite side of the cylinder relative to the emitting head.

4. The method according to claim 2, wherein said step b) is performed with the capacitive sensor arranged with its measurement axis (z) lying in a plane passing through the axis (x) of the cylinder.

5. The method according to claim 2, further comprising the step of measuring the distance of the capacitive sensor from the cylinder by means of an inductive sensor.

6. The method according to claim 1, wherein said step a) is performed by hitting the film (F) with an ionizing radiation beam (RB) emitted by an emitting head of the ionizing radiation sensor placed on one side of the film (F) and detecting the ionizing radiation beam (RB) emitted by the emitting head by means of a receiving head of the ionizing radiation sensor placed on the opposite side of the film (F).

7. The method according to claim 1, wherein said step c) of calculating the total thickness (L₁) of the first material and/or the total thickness (L₂) of the second material is based on solving the following system of equations:
$${S}_{ott} = {L}_{1} + {L}_{2}$$
$${S}_{cap} = {k}_{1} \cdot {L}_{1} + {k}_{2} \cdot {L}_{2} ,$$
wherein the parameter k₁ is determined, during the start-up of the film production plant, based on the value of said second signal (S_{cap}) when the film (F) is formed by the first material only, and
wherein the second parameter k₂ is determined during the production cycle of the film (F), based on the average value of said second signal (S_{cap}) and the average values of the total thickness (L₁) of the first material and the total thickness (L₂) of the second material, from the following equation:
$${k}_{2} = ( \overline{{S}_{cap}} - {k}_{1} \cdot \overline{{L}_{1}} ) / \overline{{L}_{2}} .$$

8. The method according to claim 7, wherein said average values of the total thickness (L₁) of the first material and the total thickness (L₂) of the second material are provided by dosing means of the film production plant.

9. An apparatus for measuring, in a multi-layer film (F) having one or more layers of a first material and one or more layers of a second material, the total thickness (L₁) of the first material and/or the total thickness (L₂) of the second material, comprising:
an optical sensor or an ionizing radiation sensor for providing a first measurement signal (Sₒₜₜ) representing in an absolute manner the total thickness of the film (F);
a capacitive sensor for providing a second measurement signal (S_{cap}) which is the sum of the signals given by the first and second material of the film (F), wherein the signal given by each material of the film (F) is a function of the thickness (L₁, L₂) of that material; and
processing means for calculating, from said first and second measurement signals (Sₒₜₜ, S_{cap}), the total thickness (L₁) of the first material and/or the total thickness (L₂) of the second material.

10. The apparatus according to claim 9, further comprising a cylinder on which the film (F) is caused to move to deviate its path, wherein the optical sensor and the capacitive sensor are arranged close to the cylinder to acquire said first measurement signal and said second measurement signal, respectively, on a section of film (F) in contact with the outer surface of the cylinder.

11. The apparatus according to claim 9, further comprising an inductive sensor associated with the capacitive sensor for measuring the distance between said capacitive sensor and the cylinder.

12. The apparatus according to claim 9, wherein the optical sensor comprises an emitting head placed on one side of the cylinder and a receiving head placed on the opposite side of the cylinder with respect to the emitting head, wherein the emitting head is configured to hit the film (F) with a focused optical beam (OB), and wherein the receiving head is configured to analyse the shadow generated by the film (F) that is being hit by the optical beam (OB) emitted by the emitting head.

13. The apparatus according to claim 9, wherein the ionizing radiation sensor comprises an emitting head placed on one side of the film (F) and a receiving head placed on the opposite side of the film (F), wherein the emitting head is configured to hit the film (F) with an ionizing radiation beam (RB) and wherein the receiving head is configured to analyse the ionizing radiation beam (RB) that has passed through the film (F).

14. The apparatus according to claim 13, wherein the capacitive sensor is mounted on the emitting head of the ionizing radiation sensor and has a through-hole aligned with the ionizing radiation beam (RB) emitted by said emitting head to allow the ionizing radiation beam (RB) to pass through the capacitive sensor.

15. A plant for producing a multi-layer film (F), comprising a measuring apparatus according to claim 9.

16. The method according to claim 5, wherein the inductive sensor is integrated in the capacitive sensor.

17. The apparatus according to claim 11, wherein the inductive sensor is integrated in the capacitive sensor.
